(19) United States
(12) Patent Application Publication
(10) Pub. No.: US 2006/0208374 A1
(43) Pub. Date: Sep. 21, 2006

(54) Method of manufacturing lens sheet

(75) Inventors: Hiroyuki Shimotsuma, Niigata-ken (JP); Makoto Soyama, Niigata (JP); Yukio Asano, Niigata (JP); Kazunari Imai, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/343,265

(22) Filed: Jan. 30, 2006

(30) Foreign Application Priority Data
Jan. 31, 2005 (JP) 2005-024042

(51) Int. Cl. B29D 11/00

(52) U.S. Cl. 264/1.7; 264/2.5

(57) ABSTRACT

A method of manufacturing a lens sheet including: a mold making process in which the flexible mold used for molding the lens portion is made; a resin pouring process in which the resin for the lens portion is poured and filled in between the mold and the glass substrate; a resin curing process in which the resin for the lens portion is cured; and a mold releasing process in which the one edge of the mold is pulled up and bended the body thereof to be separated from the glass substrate completely.

### CROSS REFERENCE TO RELATED APPLICATION

The present application claims priority from a Japanese Patent Application No. JP 2005-024042 filed on Jan. 31, 2005, the contents of which are incorporated herein by reference.

### BACKGROUND OF THE INVENTION

1. FIELD OF THE INVENTION

The invention relates to a method of manufacturing a lens sheet having plurality of microrelief structures on the whole surface thereof.

2. RELATED ART

If lens sheets, such as Fresnel lens sheets and fly-eye lens sheets have insufficient stiffness, such sheets apt to sag to contact another member partly. This causes scratches or breakages on the lens surface thereof. To improve the stiffness of the sheet, using a glass substrate for the sheet is proposed. See the Japanese Patent Application Publication No. H04-242703.

If a lens portion is molded directly on the glass substrate according to the prior art method, the glass substrate hardly bends when the mold is released from it. The bond strength between the lens and the mold is much larger than that of between the lens and the glass substrate. While if using a resin substrate, the bond strength of between the lens and the mold is smaller than that of between the lens and the resin substrate. Therefore using the glass substrate instead of the resin substrate would cause damages like breakages thereon when the mold is released from it.

### SUMMARY OF THE INVENTION

To solve the above problem, according to the first embodiment, a method of manufacturing a lens sheet including a glass substrate and a resin lens portion which is molded and formed directly on the glass substrate and has plurality of microrelief structures includes; a mold making process in which a flexible mold used for molding the lens portion is made; a resin pouring process in which a resin used for forming the lens portion is poured and filled in between the mold and the glass substrate; a resin curing process in which the resin for the lens portion is cured; and a mold releasing process in which the one edge of the mold is pulled up to bend the body of the mold to separate it from the glass substrate completely. According to the present method, the mold can be bent and separated from the lens portion with much smaller strength. Therefore, a lens sheet of large size with a glass substrate can be manufactured easily.

In the above method, the mold may be made mainly from bis (2-oxazoline), or phenoxy resin. These materials give a high durability to the mold, and allow the mold to be used repeatedly.

The above method may include a substrate treating process before the resin pouring process. In the substrate treating process, the surface of the glass substrate on which the lens portion is formed is coated by silane coupling agent. This treatment can improve the adhesion strength between the glass substrate and the lens portion.

In the above method, the resin pouring process may be operated under reduced pressure. This helps to fill the resin for the lens portion in the mold cavity completely.

In the above method, the flexible mold may have restoration potential so that after being bent in the mold releasing process, the mold to restore the shape in which the mold is used in the resin pouring process. This allows the mold to be used repeatedly for molding the lens portion, which can reduce production costs.

The above description of the present invention doesn't cite all the features of the present invention. The sub-combinations of these features may also be inventions.

### BRIEF DESCRIPTION OF THE DRAWINGS

FIG. 1 shows a structure of the rear projection display device 800 related to the present invention.

FIG. 2 is a partially enlarged view of the A area (shown in FIG. 1) of the screen unit 500.

FIG. 3 is a plan view of the Fresnel lens sheet 200.

FIG. 4 is a sectional view of the Fresnel lens sheet 200.

FIG. 5 is a partially sectional view of the Fresnel lens sheet 200 showing an example of the structure thereof.

FIG. 6 shows an example process of a method of manufacturing the Fresnel lens sheet 200.

FIG. 7 shows an example process of the method of manufacturing the Fresnel lens sheet 200.

FIG. 8 shows an example process of the method of manufacturing the Fresnel lens sheet 200.

FIG. 9 shows an example process of the method of manufacturing the Fresnel lens 200.

FIG. 10 shows an example process of the method of manufacturing the Fresnel lens 200.

FIG. 11 shows an example process of the method of manufacturing the Fresnel lens 200.

FIG. 12 explains how to test the restoration potential of the mold 30.

FIG. 13 explains how to test the restoration potential of the mold 30.

### DETAILED DESCRIPTION OF THE INVENTION

The following description explains the present invention with embodiments. The embodiments described below do not limit the invention claimed herein. All of the combinations described on the embodiments are not essential to the solutions of the present invention.

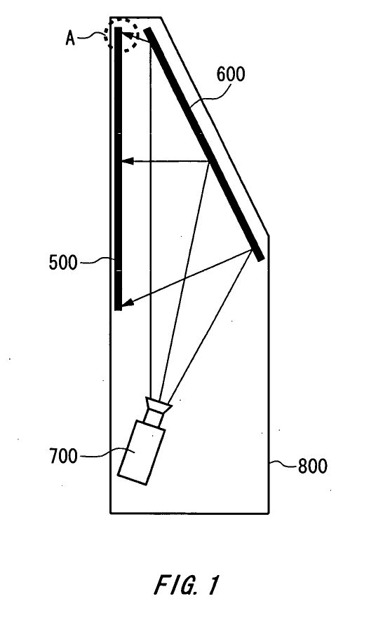

FIG. 1 shows a structure of the rear projection display device 800 which includes one embodiment of the lens sheet. The rear projection display device 800 comprises a projection unit 700, a mirror 600, and a screen unit 500. An optical image emitted from the projection unit 700 is reflected on the mirror 600, and reached the screen unit 500. The screen unit 500 transmits and spreads the optical image toward viewers who are in the viewable zone.

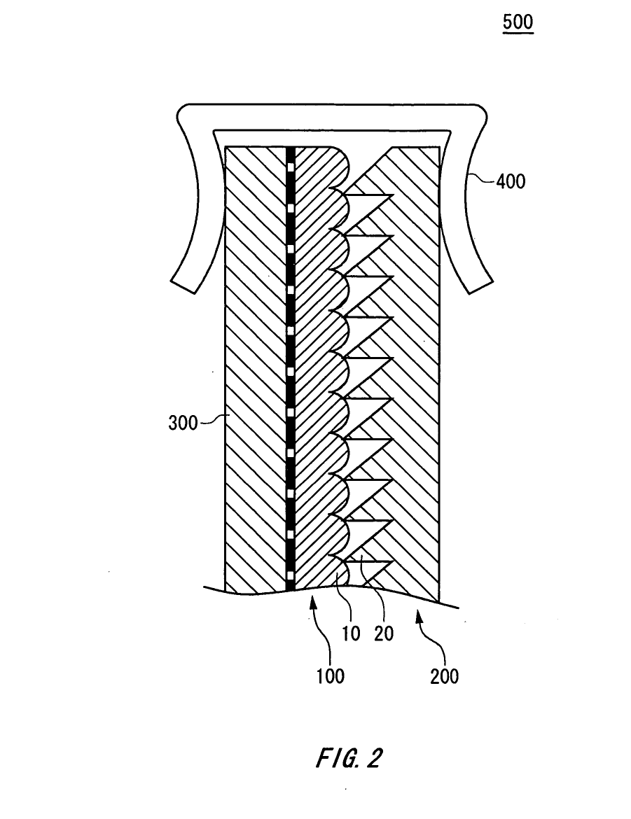

FIG. 2 shows the details the A area illustrated in FIG. 1 of the screen unit 500. The screen unit 500 comprises a Fresnel lens sheet 200, a lenticular lens sheet 100, and an outermost optical sheet 300, each of which is parallel to, and adjacent to or close to each other. The Fresnel lens sheet 200 has plurality of prisms to collimate the light, which is emitted from the projection unit 700, in the approximately perpendicular direction to the screen unit 500. The lenticular lens sheet 100 has a plurality of single hemicylindrical lenses 10 to transmit out and diffuse the incident light. The outermost optical sheet 300 protects the lenticular lens sheet 100, and prevents from reflecting outside light on the outside surface thereof which is treated with an anti-glare (AG) coating or an anti-reflection (AR) coating. The prism 20 and the single lens 10 are example elements making up the microrelief structures on the surface of the lens portion. The lenticular lens sheet 100 may be a fly-eye lens sheet.

The lenticular lens sheet 100 and the Fresnel lens sheet 200 are examples of the lens sheet of the present invention. The prism 20 and the single lens 10 are example elements making up the microrelief structures on the surface of the lens portion. The lens sheet may be a fly-eye lens sheet having a plurality of single dome lenses. In that case, the single dome lens is an example element making up the microrelief structures on the surface of the lens portion. The following explains the present embodiments with the Fresnel lens sheet 200 as an example of the present invention.

A holding means 400 binds the Fresnel lens sheet 200, the lenticular lens sheet 100, and the outermost optical sheet 300 on the edges thereof. The prisms 20 of the Fresnel lens sheet 200 face the single lenses 10 of the lenticular lens 100. The holding means 400 are arranged at four points around the edges of the screen unit 500. The holding means 400 are made of metal or resin to give grip force to the same.

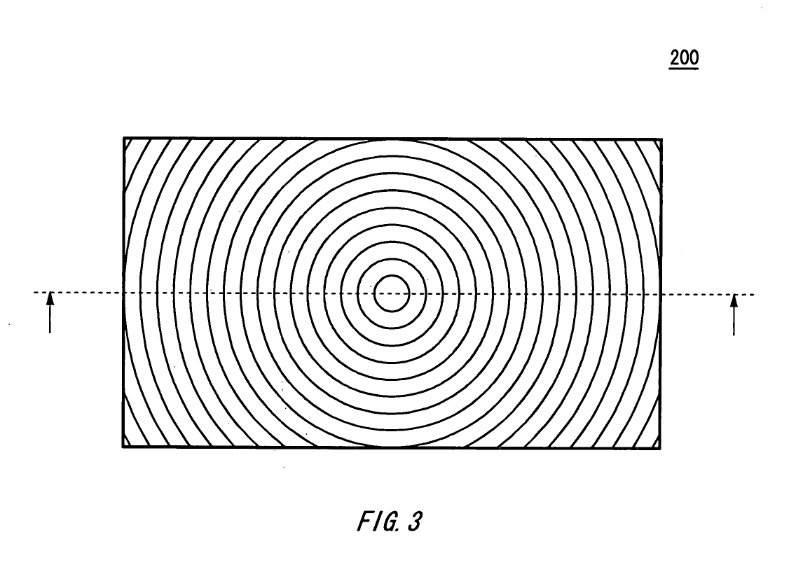

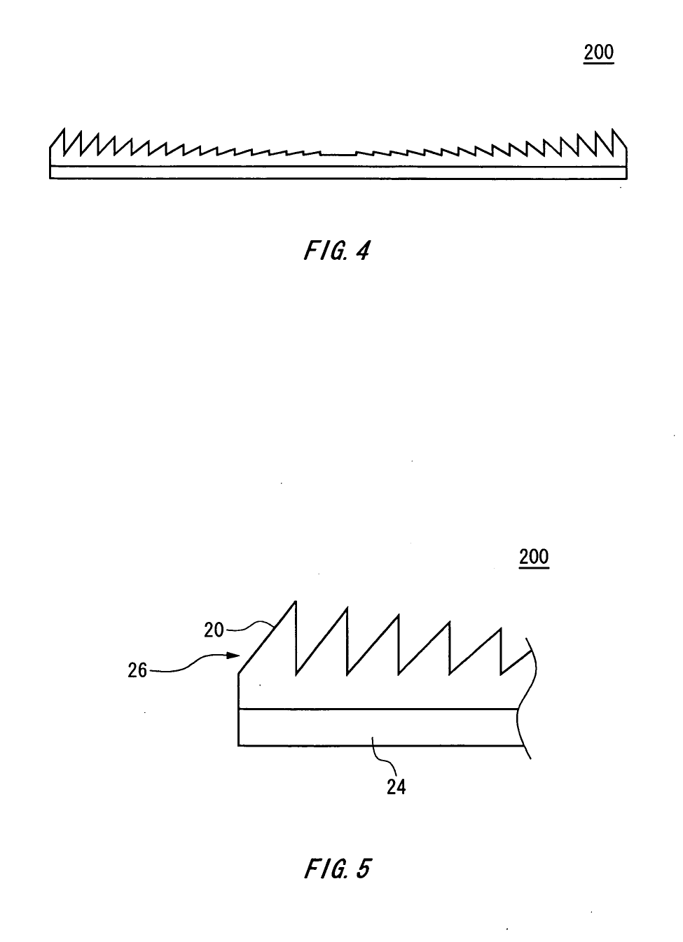

FIG. 3 shows a plan view of the Fresnel lens sheet 200. FIG. 4 shows a sectional view of the Fresnel lens sheet 200. The Fresnel lens sheet 200 has the prisms 20 aligned concentrically with no space between one another. The Fresnel lens sheet 200 has the aspect ratio required. by the application thereof. For example, when the Fresnel lens sheet 200 is used for the rear projection display device 800, the aspect ratio of the longitudinal direction to the transverse direction thereof is approximately 16:9. Another example of the aspect ratio is approximately 4:3. The height of the outer adjacent prism is larger than that of the inner adjacent prism, as shown in FIG. 4.

FIG. 5 is a sectional view showing an example layered structure of the Fresnel lens sheet 200. The Fresnel lens sheet 200 comprises a glass substrate 24 and a lens portion 26. The lens portion 26 of the present embodiment is made of UV curable, transparent urethan acrylate resin, or resin for photoreplication process (2P). The glass substrate 24 is a transparent flat glass. The glass substrate 24 has an enough thickness to assure the strength required for the Fresnel lens sheet 200. The larger the Fresnel lens sheet 200 is, the thicker the glass substrate 24 becomes. The lens portion 26 is formed integrally with the glass substrate 24 on the one surface of the glass substrate 24.

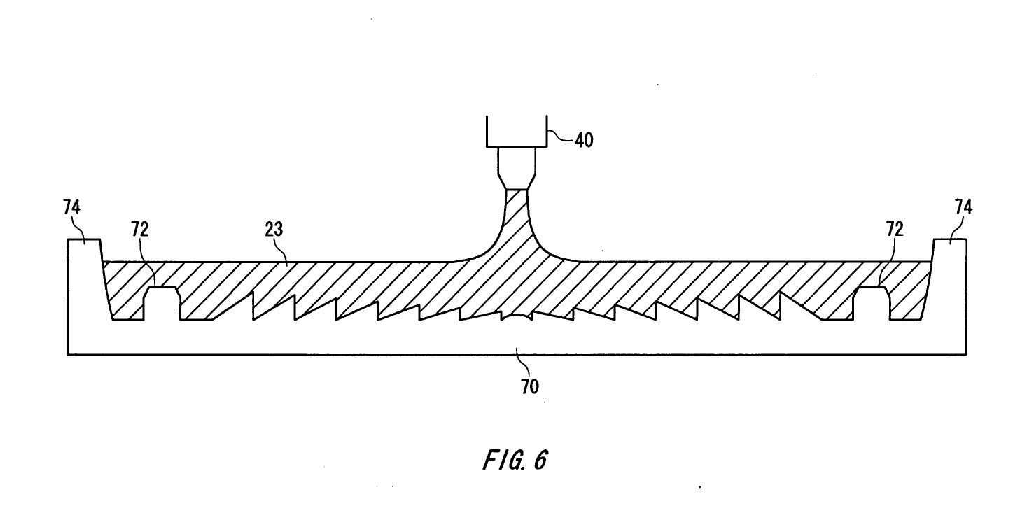

FIGS. 6 through 11 show the embodiment of method of manufacturing the Fresnel lens sheet 200. According to the present embodiment, the method of manufacturing the Fresnel lens sheet 200 includes; a mold making process in which a flexible mold 30 is made; a resin pouring process in which a resin for lens portion 21 is filled in between the mold 30 and a glass substrate 24;a resin curing process in which the resin for lens portion 21 is cured; and a mold releasing process in which the mold is released.

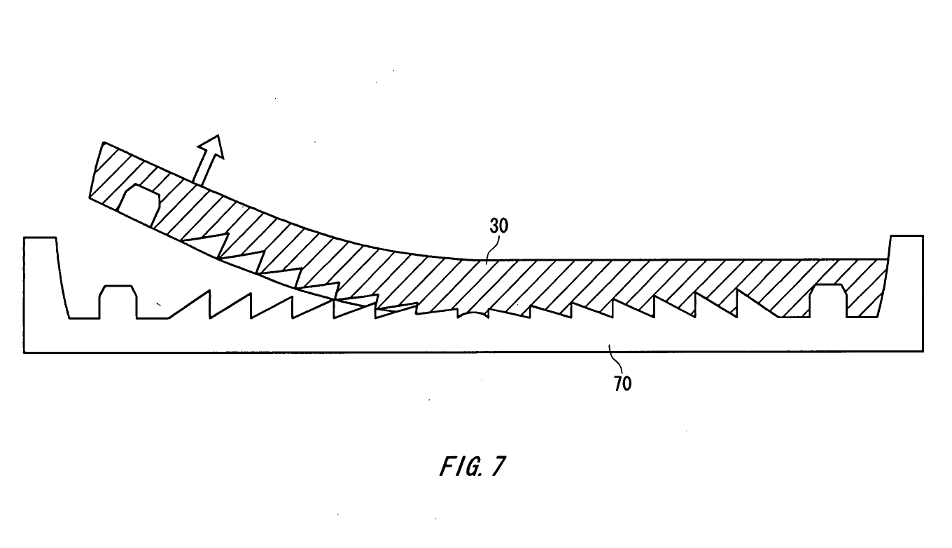

FIGS. 6 and 7 show the mold making process of the present embodiment. First prepared is a pattern 70 which has same surface having microrelief structures as that of the lens portion of the Fresnel lens sheet 200. The pattern 70 is filled with an uncured rein for mold 23 by using a dispenser 40. The pattern 70 is made of silicon rubber, for example. The pattern 70 may be manufactured by prior art methods, for example, a casting method in which a master mold, such as a metal die, made by a cutting work or a laser work is used for casting a silicon rubber. The pattern 70 has a wall 74 which surrounds the same microrelief structures bearing surface as the Fresnel lens sheet 200. The wall is taller than the height of the microrelief structures bearing surface of the pattern 70. The pattern 70 also has a bank 72 which is taller than the same microrelief structures bearing surface as the Fresnel lens sheet 200, and shorter than the wall 74. In the resin pouring process, the uncured resin for mold 23 is filled in the cavity formed by the same microrelief structures bearing surface as the Fresnel lens 200, inside the wall 74.

The resin for mold 23 contains mainly bis (2-oxazoline), or phenoxy resin. It is preferred that filling the uncured resin for mold 23 in the pattern 70 is operated in a vacuum chamber under reduced pressure so that the resin for mold 23 can be prevented from trapping air. A plate may be used for pressing against the open-air surface of the poured resin for mold 23. The plate is set and operated in parallel to the base plane of the pattern 70 so that the surface of the poured resin for mold 23 is parallel to the base plane of the pattern 70, or the bottom plane thereof shown in FIG. 6.

The resin for mold 23 filled in the pattern 70 is then cured. The resin for mold 23 which is cured in the pattern 70 will be provided as a mold 30. The cured mold 30 has flexibility. Therefore, as shown in FIG. 7, when the mold 30 is released from the pattern 70, the one edge of the mold 30 is pulled up as bending the body of the mold 30 to separate from the pattern 70 completely.

The following explains that the embodiments of the mold making processes with using bis (2-oxazoline), and using phenoxy resin as the major component of the resin for mold 23, respectively. When bis (2-oxazoline) is used as the major component, the total material composition contains; a) 291.6 part by weight of 2,2′-(1,3-phenylene) bis (2-oxazoline); b) 198 part by weight of dimeric or trimeric diamine; c) 56.4 part by weight of dicarboxylic acid; d) 340 part by weight of bisphenol F type epoxy resin (epoxy equivalent 170-180); and e) 1 part by weight of 1,4-dibromobutane as a catalyst.

The components a, b, and c are mixed together, and prereacted at 120° C. for one hour. The components d and e are added to the mixed components. The all mixed material is poured and filled in the pattern 70 to be fully reacted. The fully reacting procedure is operated first at 80° C. for 8 hours, next at 120° C. for 3 hours, which is stepped cure, finally at 140° C. for 3 hours as a post-cure.

The other composition using phenoxy resin mainly for the resin for mold 23 contains; p) 55 weight by part of bisphenol F; q) 100 weight by part of bisphenol F type epoxy resin; and r) 2.0 weight by part of triphenylphosphine.

These components are mixed in the following way. The components p, q, and r are melted and mixed together to provide a resin composition. The resin composition is cured in steps (stepped cure) on the following condition: 1) at 90° C. for 6 hours; and 2) at 120° C. for 4 hours. The above compositions and reaction and curing conditions are just examples.

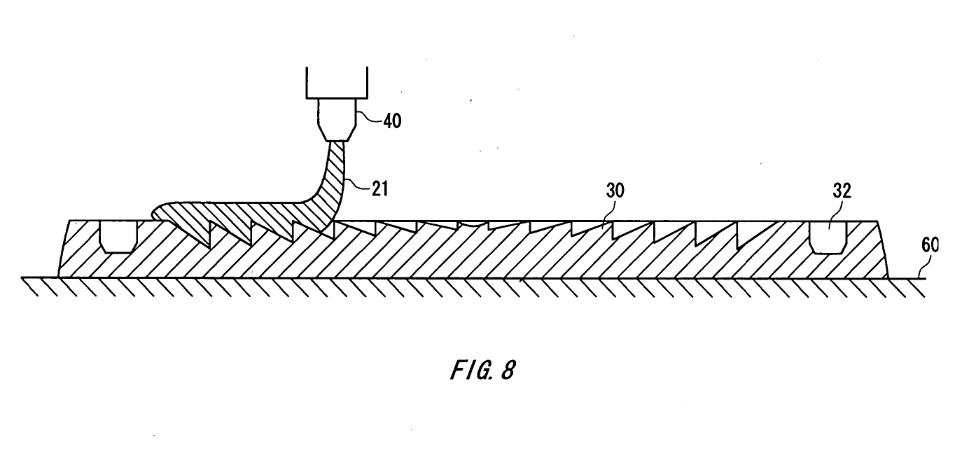

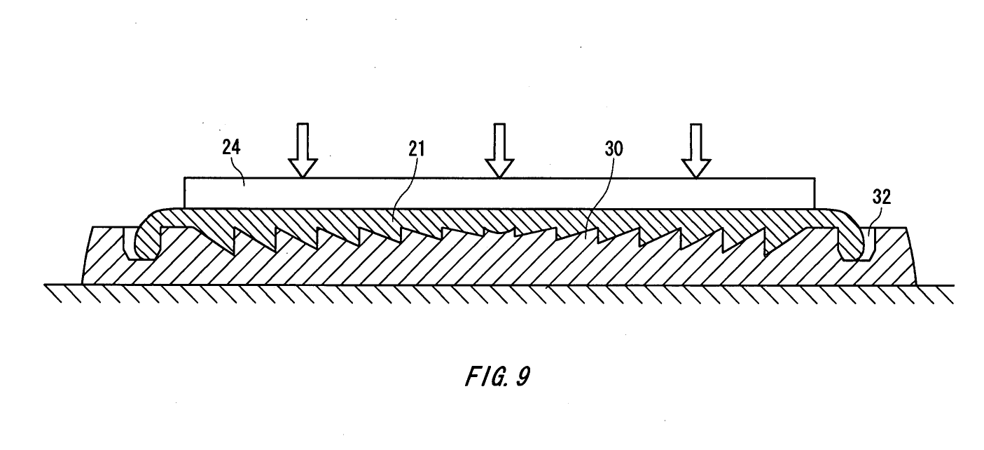

FIGS. 8 and 9 show the resin pouring process in which the resin for lens portion 21 is poured and filled in between the mold 30 and the glass substrate 24. The mold 30 made in the mold making process is put on the flat bed 60 with the mold cavity facing up. The mold cavity has the negative pattern of the lens portion 26. The mold 30 is flexible. So as to keep the mold 30 flat, it is put on the flat bed 60. As shown in FIG. 8, the uncured resin for lens portion 21 is poured with a dispenser 40 to be filled in the mold cavity of the mold 30. The resin for lens portion 21 is a transparent UV curable resin, for example, urethan acrylate resin. The uncured resin for lens portion 21 of the present embodiment is high-viscosity fluid.

The glass substrate is then prepared. Silane coupling agent is coated on the one side of the glass substrate 24 so that the glass substrate 24 sticks to the lens portion 26 more tightly. The glass substrate 24 may be coated with the silane coupling agent and treated with heat. After the heat treatment, the glass substrate 24 is rinsed with a solvent such as water to remove excess silane coupling agent thereon. This allows coating the silane coupling agent evenly on the glass substrate 24. The silane coupling agent coated on the glass substrate 24 helps to increase the adhesion strength between the glass substrate 24 and the lens portion 26, or between the inorganic and organic materials.

The glass substrate 24 is then attached the silane coupling agent coated side thereof to the uncured lens portion. The glass substrate 24 is then pressed down against the mold 30. The glass substrate 24 is pressed down so that the distance from the virtual plane on top of the prisms 20 of the mold 30 to the upper surface of the glass substrate 24 is equal to the required height from the bottom of the prism 20 to the open-air surface of the glass substrate. The glass substrate 24 is pressed down on the upper surface thereof, shown in FIG. 9, in a vacuum chamber to reduce the pressure around the mold 30. This prevents the resin for lens portion 21 from trapping air and to be filled in the mold cavity of the mold 30, which becomes the lens portion 26. A trench 32 is formed around the cavity for the lens portion 26 of the mold 30. The trench 32 is molded correspondingly to the bank 72 of the pattern 70. The trench 32 dams the resin for lens portion 21 flowing over the edges of the glass substrate 24.

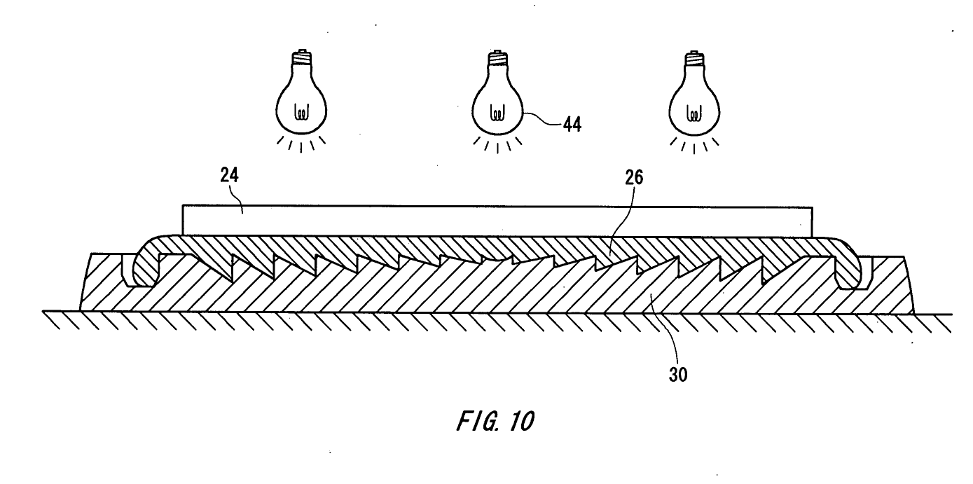

FIG. 10 shows the resin curing process of the present embodiment. The resin curing process is operated at atmosphere pressure. In the resin curing process, the resin for lens portion 21 is cured by being irradiated ultra violet light through the glass substrate 24. UV lumps 44 are used for the UV irradiation. The UV lumps 44 set above the glass substrate 24 irradiates UV light for enough time to cure the resin for lens portion 21. After the UV light irradiation, the pressure inside the vacuum chamber is increased to atmosphere pressure. The cured resin for lens portion 21 forms the lens portion 26.

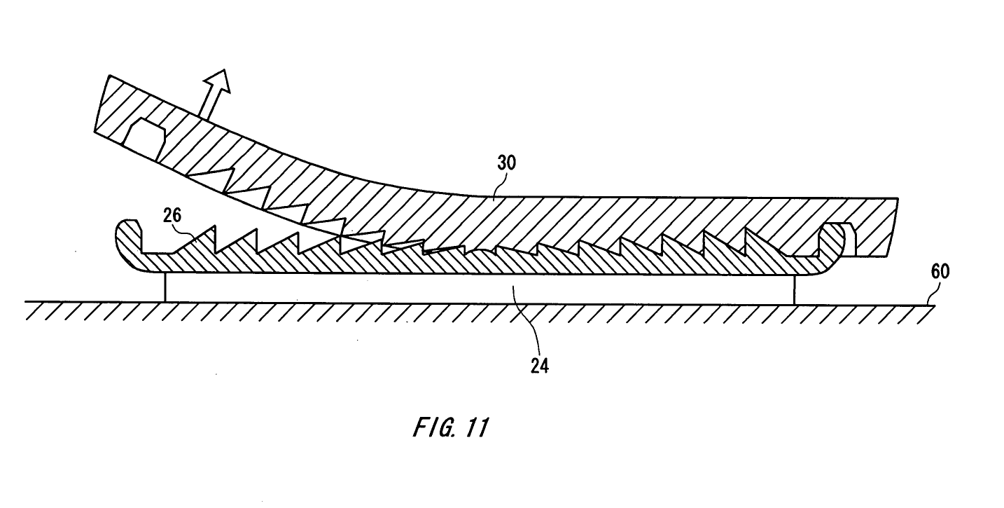

FIG. 11 shows the mold releasing process. In the mold releasing process, the mold 30 is released from the layers of the glass substrate 24 and lens portion 26. Following to the curing process, the combination of the mold 30, lens portion 26, and the glass substrate 24, shown in FIG. 10, is turned upside down. The side of the glass substrate 24 is faced down, and the side of the mold 30 is faced up. The one edge of the mold 30 is pulled up and bended the body thereof to separate the mold 30 from the glass substrate 24 to the opposite edge. The mold 30 is released from the lens portion 26 in this manner. After releasing the mold 30, the layers of the glass substrate 24 and the lens portion 26 are cut out in the required size for the screen unit 500 to be provided as the Fresnel lens 200. It is preferred that the flexible mold 30 has restoration potential so that the released mold 30 restores the shape in which the mold 30 is in the resin pouring process. This allows the mold 30 to be used repeatedly for molding the lens portion, which can reduce manufacturing costs.

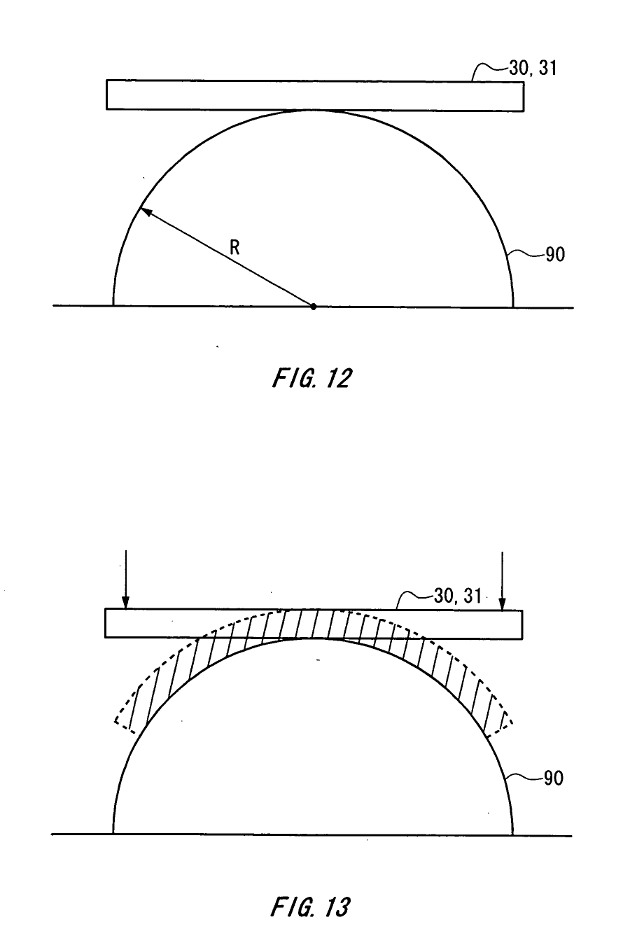

FIGS. 12 and 13 show how to test the restoration potential of the mold 30. The following explains the restoration potential of the resin mold 30 of the present embodiment compared to that of an electrocast mold 31, which is an example of a conventional metal mold. The electrocast mold 31 is, for example, a nickel electrocast mold. Test samples of the resin mold 30 and the electrocast mold 31 are prepared. Two samples of the resin mold 30: 20 mm wide, 200 mm long, and 2.3 mm and 3.7 mm thick respectively Two samples of the electrocast mold 31: 20 mm wide, 200 mm long, and 0.5 mm and 2.0 mm thick respectively

The samples were bended certain times. The degrees of warpage of the samples are shown below. Hyphens “-” shown in the table stand for no value because the sample could not keep on being tested.

| | | TABLE | | | |
|---|---|---|---|---|---|
| | | Degree of warpage (mm) | | | |
| | | Electrocast mold | | Resin mold 30 | |
| Material | Number of | 31 (Thickness/mm) | | (Thickness/mm) | |
| R(mm) | times | 0.5 t | 2.0 t | 2.3 t | 3.7 t |
| 160 | 0 | 0.0 | 0.0 | 0.0 | 0.0 |
| | 1 | 2.5 | 9.5 | 0.0 | 0.0 |
| | 5 | 2.5 | 12.0 | 0.0 | 0.3 |
| | 10 | 3.0 | — | 0.0 | 0.3 |
| | 20 | 3.0 | — | 0.0 | 0.3 |
| | 50 | 3.0 | — | 0.3 | 0.3 |
| | 100 | 3.0 | — | 0.3 | 0.8 |
| 240 | 0 | 0.0 | 0.0 | 0.0 | 0.0 |
| | 1 | 0.5 | 6.0 | 0.0 | 0.0 |
| | 5 | 1.0 | 7.0 | 0.0 | 0.0 |
| | 10 | 1.0 | 7.0 | 0.0 | 0.0 |
| | 20 | 1.0 | 7.5 | 0.0 | 0.0 |
| | 50 | 1.0 | 7.5 | 0.0 | 0.3 |
| | 100 | 1.0 | — | 0.3 | 0.3 |

The 2 mm thick electrocast mold 31 generates 6.00 or more warpage on just one bending when Rs are 160 m and 240 mm. The 0.5 mm thick sample of the electro mold 31 was bended over 10 times to generate 3.0 mm warpage when R was 160 mm. The sample was bended over 5 times to generate 1.0 mm warpage when R was 240 mm.

The 3.7 mm thick sample of the resin mold 30 of the present embodiment generated 0.3 mm warpage on 50 times generate 0.3 mm warpage on 100 times bending, when R was 160 mm in both cases. The 2.3 thick sample of the resin mold 30 of the present embodiment was bended 100 times to generate 0.3 mm warpage when Rs were 160 mm and 240 mm. The both samples of the resin mold 30 were restored with no warpages after being left in 5 minutes. Apparently from the above results, the resin mold 30 of the present embodiment has much higher restoration potential than the conventional electrocast mold 31. The high restoration potential of the mold 30 provides another merit that it can be used repeatedly for manufacturing lens sheets having a glass substrate.

As apparently shown in the above description, according to the present embodiment, the mold 30 can be bent to be separated gradually from the lens portion 26 in the mold releasing process. The required force for releasing the mold 30 in this way is much smaller than that for releasing the mold 30 without bending, or removing in parallel to the glass substrate 24. This releasing method can be applied to manufacture large lens sheets having a glass substrate easily without breaking the glass substrate 24. The repeated use of the mold 30 allows reducing manufacturing costs of the lens sheets.

The above description explaining the present invention with the embodiments does not limit the technical scope of the invention to the above description of the embodiments. It is apparent for those in the art that various modifications or improvements can be made to the embodiments described above. It is also apparent from what we claim that other embodiments with such modifications or improvements are included in the technical scope of the present invention.

What is claimed is:

1. A method of manufacturing a lens sheet having a glass substrate, and a resin lens portion which is formed and molded directly on the glass substrate and has plurality of microrelief structures includes;
a mold making process wherein a mold being flexible and used for molding said lens portion is made;
a resin pouring process wherein resin for said lens portion is poured and filled in between said mold and said glass substrate;
a resin curing process wherein the resin for said lens portion is cured; and a mold releasing process wherein the one edge of said mold is pulled up and bended the body of said mold to be separated from said glass substrate completely.

2. The method of manufacturing a lens sheet according to claim 1, wherein said mold is made mainly of bis (2-oxazoline) or phenoxy resin.

3. The method of manufacturing a lens sheet according to claim 1, also including a substrate treating process wherein silane coupling agent is coated on the surface of said glass substrate on which said lens portion is formed.

4. The method of manufacturing a lens sheet according to claim 1, wherein said resin curing process is operated under reduced pressure.

5. The method of manufacturing a lens sheet according to claim 1, wherein said flexible mold has restoration potential so that after being bent in said mold releasing process, said mold is restore the shape in which said mold is in said resin pouring process.
